(19) United States
(12) Patent Application Publication
(10) Pub. No.: US 2007/0134133 A1
(43) Pub. Date: Jun. 14, 2007

(54) Detector for detecting molecules conveyed through a gaseous medium

(76) Inventors: Wu Wenzhi, Kogarah (AU); Donald Barnett, Hornsby Heights (AU); Graham Bell, Hunters Hill (AU); Brian Crowley, Balmain (AU); Brynn Hibbert, Randwick (AU); David Charles Levy, Bellevue Hill (AU); Arvind Kumar Srivastava, Des Plaines, IL (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/585,355

(22) Filed: Oct. 23, 2006

Related U.S. Application Data
(63) Continuation of application No. PCT/AU05/00563, filed on Apr. 21, 2005.

(30) Foreign Application Priority Data
Apr. 21, 2004 (AU) 2004 902132
Apr. 21, 2004 (AU) 2004 902133
May 20, 2004 (AU) 2004 902710

(51) Int. Cl. G01N 27/00

(52) U.S. Cl. 422/98

(57) ABSTRACT

The present invention provides a detector for detecting molecules conveyed through a gaseous medium. For example, the molecules may be emitted from sewage, meat production plants, or detection of the molecules may give information about a state of health of a human or an animal. The detector comprises sensors which have sensing surfaces. Each sensing surface has an electrical property that changes in response to the molecules when the molecules are coupled to the sensing surface so that the coupled molecules can be sensed by detecting the changed electrical property. The sensors are sensitive for a sulphur compound and for an organic compound. The present invention also provides a method of fabricating a detector for detecting molecules conveyed through the gaseous medium.

This application is a continuation of PCT/AU2005/000563 filed Apr. 21, 2005, and claims priority to Australian application No. 2004 902132 filed Apr. 21, 2004, and Australian application No. 2004 902133 filed Apr. 21, 2004, and Australian application No. 2004 902710 filed May 20, 2004, which are incorporated herein by reference.

### FIELD OF THE INVENTION

The present invention relates to a detector for detecting molecules conveyed through a gaseous medium and relates particularly, though not exclusively, to a detector for an odour such as an airborne odour.

### BACKGROUND OF THE INVENTION

The pollution of air or water is an environmental problem that is of growing concern. This is true not only for pollution that results from heavy industry and machines such as automobiles, but also for pollution that is directly associated with animals or humans. In many countries the allowable emission of such odours is now regulated.

One source of such odours are sewage processing plants. Sewage is normally processed in two stages and in both stages odours are produced that are of concern to operators of the plant because of complaints from the community that is exposed to them. In a first stage a relatively large amount of H₂S typically is emitted which is monitored using a dedicated H₂S sensor. The H₂S emission typically is accompanied by organic odours such as fecal odours which are of great concern for the neighbouring community. When H₂S emission is monitored, it is assumed that these organic odours are also present with intensity that is related to the intensity of the monitored H₂S. However, the monitoring of H₂S is an unreliable technique to quantify the emission of H₂S (and indirectly the emission of organic compounds) from the sewage processing plant as there can be other H₂S emission sources in the vicinity of the plant such as automobiles. At a second stage of the sewage processing the H₂S emission is greatly reduced but organic odours are still emitted which are not monitored at the sewage processing plant.

Another source of such odours are meat producing and livestock processing plants which are often relatively large operations and which emit odours that are unpleasant for the community living in the proximity of such plants.

In many countries the allowable emission of such odours is now regulated. However, detectors for odours are often very complicated and expensive devices and comprise large arrays of sensors. Further, the operation of the detectors has practical problems that relate to the fact that in use the detectors are exposed to contaminating odours.

There is a need for alternative technical solutions.

### SUMMARY OF THE INVENTION

The present invention provides in a first aspect a detector for detecting molecules conveyed through a gaseous medium, the detector comprising:

at least one sensor, the or each sensor having a sensing surface which has an electrical property that changes in response to the molecules when the molecules are coupled to the sensing surface so that the coupled molecules can be sensed by detecting the changed electrical property, the sensor being sensitive for a sulphur compound and for an organic compound.

When it is said that the molecules “couple” to the sensing surface, the term “couple” is to be interpreted broadly to include adsorption, absorption, trapping in pores and other bonding mechanisms including any type of weak or strong chemical bonding.

The molecules conveyed through a gaseous medium typically relate to an odour. For example the gaseous medium may be air and the molecules conveyed through the air may be associated with human or animal related organic waste that give rise to the odour. Particular examples include waste from sewage plants, rubbish processing plants or other sources of odours. Alternatively, the odour may be an odour associated with that of a plant for processing red or white meat such as meat from cattle, sheep or chicken. However, the molecules conveyed through the gaseous medium may also be odourless. The molecules conveyed through the gaseous medium may also be molecules which are of detriment for the quality of air in buildings, for the quality of food or for the quality of any other matter or molecules with which humans may be in contact or to which humans may be exposed. Further, the molecules conveyed through air may be molecules which can be detected to diagnose health states of humans or animals.

The detector typically comprises a plurality of sensors, each sensor having a sensing surface, at least one of the sensing surfaces being sensitive for the organic compound and at least one other sensing surfaces being sensitive for the sulphur compound. The detector typically comprises chemical sensors. For example, the detector may comprise two to five chemical sensors which may be arrayed. Each sensor surface typically is a surface of one of the chemical sensors. Each sensor typically comprises an oxide such as a metal-oxide. Typically the metal oxide is tin-oxide.

The or each sensor that is sensitive for the organic components typically is sensitive for at least one of CO; volatile fatty acids (such as valeric, isovaleric, butyric acids); ammonia; hydrocarbons such as methane, isobutane, propane, toluene, xylene; aromatics; alcohols such as ethanol; and oxygenated compounds. Further, the detector may comprise sensors for ambient temperature and humidity.

The detector typically is also arranged to produce electronic data and may comprise an output port for connection to a computer.

In a specific embodiment the odour is an odour emitted from a sewage plant. In this case the at least one sensor that is sensitive for the sulphur compound typically is arranged to detect H₂S or a related compound. The at least one sensor for an organic compound typically is arranged to detect organic compounds that are emitted from the sewage plant. In this case it is possible to monitor the H₂S emission during the first stage of the sewage processing at the sewage plant and also directly monitor the emission of organic compounds which are of great concern for communities in the proximity of the sewage plant. Further, during the second stage of the sewage processing the emission of organic odours can also be monitored which provides a significant advantage.

In another specific embodiment the odour is associated with red meat and may arise from a red meat processing plant which may process red meat from cattle or sheep. The inventors have observed that the most dominant components of an odour from a red meat processing plant arise from organic compounds, in particular aldehydes, and from sulfur compounds, in particular reduced sulfur compounds. Therefore, the detector may be relatively simple and may only comprise sensors for the dominant components of the odour. At least one of the sensing surfaces typically is sensitive for aldehydes and at least one of the sensing surfaces typically is sensitive for reduced sulfur compounds. The or each sensor that is sensitive for the organic components typically is sensitive for at least one of propane, methane, an alcohol, and an organic vapour. The or each sensor that is sensitive for a sulfur compound typically is sensitive for a thiol. For example, the detector may comprise separate sensors for propane, methane, an alcohol, organic vapour and a sulfur compound.

In an alternative embodiment the odour is associated with white meat and may arise from a white meat processing plant which may process white meat from chicken.

The present invention provides in a second aspect a method for detecting molecules conveyed through a gaseous medium, the method comprising the steps of:

exposing a detector having at least one sensor to the molecules, the or each sensor being sensitive for organic molecules and for molecules that contain sulphur and

measuring a change of an electrical property of the sensor and thereby detecting the molecules.

The step of exposing a sensor typically comprises:

exposing a first sensing surface to the molecules, the first sensing surface being sensitive for an organic compound and

exposing a second sensing surface to the molecules, the second sensing surface being sensitive for a sulphur compound.

In this case the step of measuring a change of an electrical property typically comprises measuring a change of an electrical property of the first and second sensing surfaces and thereby detecting the molecules.

In the second aspect of the present invention the molecules conveyed through a gaseous medium typically relate to an odour. For example the gaseous medium may be air and the molecules conveyed through the air may be associated with human or animal related organic waste that give rise to an odour. Particular examples include waste from sewage plants, rubbish processing plants or related sources of odours. However, the molecules conveyed through the gaseous medium may also be odourless. The molecules conveyed through the gaseous medium may also be molecules which are of detriment for the quality of air in buildings, for the quality of food or for the quality of any other matter or molecules with which humans may be in contact or to which humans may be exposed. Further, the molecules conveyed through air may be molecules which can be detected to diagnose health states of humans or animals.

In one embodiment the first sensing surface is sensitive for at least one of CO; volatile fatty acids (such as valeric, isovaleric, butyric acids); ammonia; hydrocarbons such as methane, isobutane, propane, toluene, xylene; aromatics; alcohols such as ethanol; and oxygenated compounds. The second surface typically is sensitive for H₂S or a related sulphur compound. Such a detector is particularly suitable for the detection of an odour associated with sewage.

Alternatively, the molecules conveyed through air may relate to an odour associated with red meat. In this case the first surface typically is sensitive for aldehydes and the second surface typically is sensitive for a reduced sulfur compound. The step of exposing a first sensing surface to the odour typically comprises exposing a first sensing surface that is sensitive for at least one of propane, methane, an alcohol, and an organic vapour to the odour.

The present invention provides in a third aspect a method of fabricating a detector for detecting molecules conveyed through a gaseous medium, the detector having at least one sensor, the method comprising the steps of:

determining types of molecules that dominate the molecules conveyed through the gaseous medium,

selecting the at least one sensor such that the or each sensor is sensitive for at least one of the determined type of molecules and

fabricating the detector having the or each sensor.

The term “dominate” is used to indicate that the molecules dominate in terms of an odour intensity, or a proportion, amount, mass, volume or density of the molecules.

As in the first and second aspects of the present invention, in the third aspect of the present invention the molecules conveyed through a gaseous medium typically relate to an odour. For example the gaseous medium may be air and the molecules conveyed through the air may be associated with human or animal related organic waste that give rise to an odour. Particular examples include waste from sewage plants, rubbish processing plants or any other sources of odours such as red meat processing plants. However, the molecules conveyed through the gaseous medium may also be odourless. The molecules conveyed through the gaseous medium may also be molecules which are of detriment for the quality of air in buildings, for the quality of food or for the quality of any other matter or molecules with which humans may be in contact or to which humans may be exposed. Further, the molecules conveyed through air may be molecules which can be detected to diagnose health states of humans or animals.

The detector typically comprises at least two sensors; at least one sensor typically is sensitive for an organic compound and at least one sensor typically is sensitive for a sulphur compound, such as H₂S or a related compound.

In a specific embodiment of the third aspect of the present invention the step of determining types of molecules that dominate the molecules conveyed through a gaseous medium typically comprises determining types of molecules that dominate an odour such as an odour from a sewage or meat processing plant.

In one embodiment of the third aspect of the present invention the at least two sensors comprise respective sensors for H₂S and at least one of CO; volatile fatty acids (such as valeric, isovaleric, butyric acids); ammonia; hydrocarbons such as methane, isobutane, propane, toluene, xylene; aromatics; alcohols such as ethanol; and oxygenated compounds. Such a detector is particularly suitable for the detection of odours related to sewage.

In another specific embodiment of the third aspect of the present invention the molecules conveyed through the gaseous medium are associated with an odour arising from red meat such as an odour associated with a red meat processing plant. As mentioned above, the inventors have observed that the types of molecules that dominate the odour associated with red meat are organic compounds, in particular aldehydes, and sulfur compounds, in particular reduced sulfur compounds. Therefore, the detector typically comprises at least two sensors at least one sensor is sensitive for an organic compound, such as aldehydes, and at least one sensor is sensitive for a sulfur compound, such as reduced sulfur compounds.

Alternatively, the molecules conveyed through the gaseous medium may be associated with an odour arising from white meat.

In a specific embodiment the at least two sensors comprise respective sensors for propane, methane, an alcohol, organic vapour and a sulfur compound.

The present invention provides in a fourth aspect a detector fabricated by the method according to the third aspect of the present invention.

The present invention provides in a fifth aspect a detector for detecting molecules conveyed through a gaseous medium, the detector comprising:

a sensor having at least one sensing surface, the or each sensing surface having an electrical property that changes in response to the molecules when the molecules are coupled to the or each sensing surface so that the coupled molecules can be sensed by detecting the changed electrical property and

a device for directing a fluid that is substantially free of the molecules to be detected to the or each sensor surface, the device having a control mechanism for controlling an amount of the fluid that is directed to the or each sensor surface.

In the fifth aspect of the present invention the molecules conveyed through the gaseous medium typically result in an airborne odour and the detector typically is a detector for the airborne odour. However, the molecules conveyed through the gaseous medium may also be odourless. The molecules conveyed through the gaseous medium may also be molecules which are of detriment for the quality of air in buildings, for the quality of food or for the quality of any other matter or molecules with which humans may be in contact or to which humans may be exposed. Further, the molecules conveyed through air may be molecules which can be detected to diagnose health states of humans or animals.

The device for directing a fluid may comprises a manifold that is arranged so that the fluid is guided to the or each sensor surface. For example, the device for directing the fluid may be arranged to clean and/or calibrate the or each sensor. The control mechanism may be electronic and may be remotely controlled so that the electronic control mechanism can be activated from a remote location. In this case the detector may be arranged for remotely controlled cleaning and/or calibrating of the or each sensor. Alternatively or additionally, the detector may have a timer that is arranged to activate the control mechanism in predetermined time intervals so that the or each sensor can be cleaned and/or calibrated in the predetermined time intervals.

The detector according to the fifth aspect of the present invention may also be arranged to flush the or each sensor surface with the fluid, such as clean air or any other suitable fluid, to remove adsorbed molecules such as adsorbed odour molecules, from the or each sensor surface. For example, the device may have a pump or blower for the fluid. If the detector is installed at a meat processing plant, the odour molecules will adsorb on the or each sensor surface and frequent cleaning of the or each surface will be necessary. If the detector is remotely controlled or has a timer or is otherwise controlled (eg by a processor), the pump or blower typically is arranged for automatic or remotely controlled operation. In this case it is possible to direct the fluid to the or each sensor surface when the detector is installed in the proximity of source of the molecules, from a remote location or in an automated manner.

The fluid may comprise filtered air. The device typically also comprises a filter, such as an active carbon filter, to filter and thereby clean air so that substantially clean air is directed to the or each sensor surface.

For calibration purposes, the device for directing a fluid may also be arranged to direct a known quantity or concentration of a fluid to the or each sensor surface for which a calibrated sensor surface would give known response. For example, the fluid may also comprise an alcohol such as ethanol. The fluid typically comprises a vapour such as an ethanol vapour in air. In this case the device typically comprises a vapour generator that is arranged to generate a vapour having predetermined concentration.

The detector according to the fifth aspect of the present invention typically comprises a means to adjust a sensitivity of the or each sensor such as a means for adjusting an electronic amplification. As it is known what the sensor response should be during or after directing the fluid to the sensor surfaces, the or each sensor can be adjusted, if necessary, so as to calibrate the or each sensor.

If the device for directing a fluid is remotely operated, the detector typically is arranged for automatic operation or for remote control. In this case it is possible to calibrate the or each sensor when the detector is installed in the proximity of a source of the molecules, for example a meat processing plant, from a remote location or in an automated manner.

The detector according to the fifth aspect of the present invention typically comprises an array of chemical sensors. For example, the array may comprise five chemical sensors. Each sensor surface typically is a surface of one of the chemical sensors. Each sensor typically comprises an oxide such as a metal-oxide. Typically the metal oxide is tin-oxide.

In one specific embodiment the detector according to the fifth aspect of the present invention comprises an arrangement for mounting sensors. In this embodiment, the arrangement allows the sensors to be exchanged and/or interchanged so that the sensors of the detector can be selected to suit a particular requirement.

The present invention provides in a sixth aspect a method of detecting molecules conveyed through the air using the detector according to the fifth aspect.

The method typically comprises the steps of flushing the or each sensor surface with the fluid that is substantially free of the molecules to clean the or each sensor surface from contaminating molecules and thereafter exposing the or each surface to the molecules conveyed through the gaseous medium. This step typically comprises detecting a rate at which an electrical signal associated with the coupling of the molecules changes. Further, this step typically comprises detecting a maximum of an electrical signal associated with the coupling of the molecules conveyed through the gaseous medium to the or each surface.

The method according to the sixth aspect of the present invention is particularly advantageous for diagnostic purposes. For example, detection of the molecules conveyed through the gaseous medium may give information about the state of health of a human or an animal. In one specific embodiment the method is used to detect molecules emitted or exhaled by animals, such as sheep, cattle or chicken, or humans. For example, the method may be employed for diagnosis of lung cancer.

The invention will be more fully understood from the following description of a specific embodiment of the invention. The description is provided with reference to the accompanying drawings.

### BRIEF DESCRIPTION OF THE DRAWINGS

FIG. 1 shows a schematic representation of a detector according to an embodiment of the invention,

FIG. 2 shows a voltage versus time plot of a typical response of a detector according to an embodiment of the present invention,

FIG. 3 shows a voltage versus time plot of a typical response of a detector according to another embodiment of the present invention,

FIG. 4 shows a schematic representation of a detector for detecting molecules conveyed through a gaseous medium according to a further embodiment of the invention,

FIG. 5 shows a schematic representation of a detector for detecting molecules conveyed through a gaseous medium according to another embodiment of the invention and

FIG. 6 shows a schematic representation of a detector system for detecting molecules conveyed through a gaseous medium according to yet another embodiment of the present invention.

### DETAILED DESCRIPTION OF A SPECIFIC EMBODIMENT

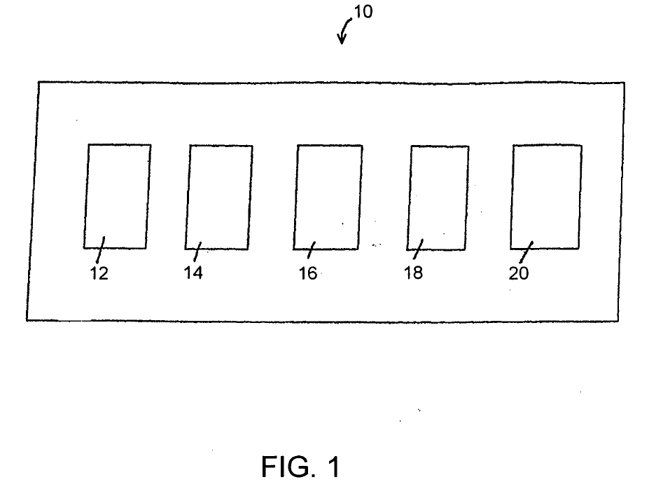

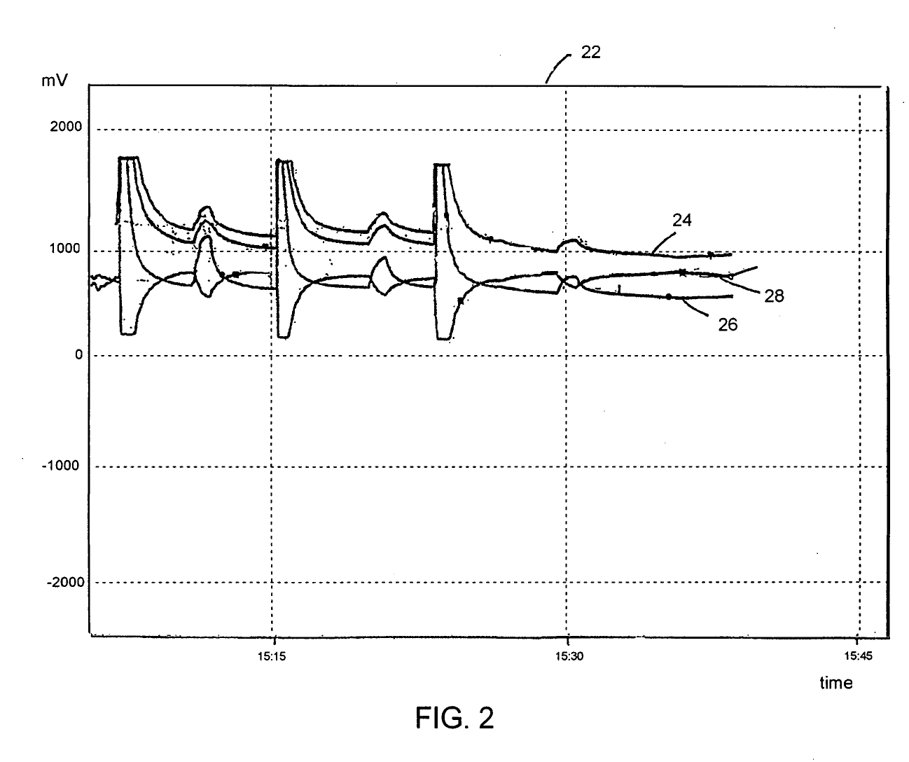

Referring to FIGS. 1 and 2, a detector for detecting molecules conveyed through a gaseous medium and a method of detecting the molecules are now described. In a first embodiment the molecules conveyed through a gaseous medium relate to an odour from a sewage processing plant. However, it is to be appreciated that the present invention is not limited to this application. Other examples include the detection of odours from rubbish processing plants, chemical plants or any other small or large-scale facilities, including domestic facilities, which emit odour. Further, it is to be appreciated that the molecules may relate to an odourless fluid such as an odourless toxic gas (for example carbon monoxide).

FIG. 1 shows the detector 10 which in this embodiment comprises five sensors 12, 14, 16, 18 and 20.

In this embodiment the sensors are tin-oxide sensors which have surfaces that are particularly sensitive for specific compounds. The sensors are exposed to the odour and molecules related to the odour adsorb at the sensor surfaces and are detectable as the electrical properties of the surfaces change when a quantity of the molecules are adsorbed at the surfaces. In this specific example, the detector comprises sensors manufactured by FIGARO.

The five sensors 12 to 20 are selected to be sensible for low level volatile organic compounds and sulphur compounds (sensor TGS 2100); oxygenated compounds, ethanol, hydrogen, toluene, xylene, and organic compounds (sensor TGS 2620); hydrocarbons, aromatics, incl CO, methane isobutane and propane (sensor TGS 2610). In addition, the detector 10 comprises two sensors for volatile fatty acids (valeric, isovaleric, butyric acids) and ammonia.

FIG. 2 shows a typical intensity versus time response 22 of the sensors TGS 2620 (plot 24), TGS 2100 (plot 28) and TGS 2610 (plot 26) to an odour emitted from a sewage processing plant (the responses from the sensors volatile fatty acids, ammonia, temperature and for humidity are not shown).

The detector 10 comprises electronic components (not shown) that detect the changes of the electrical sensor surface properties and generate electronic data that is associated with a quantity of the detected compounds. The electronic data is directed to an output (not shown) of the detector 10 which can be connected to a computer so that the electronic data can be processed using a computer software routine.

Before fabricating the detector 10, types of molecules that dominate the odour are determined. If the odour originates from a sewage processing plant, the types of molecules that are characteristic for the odour are organic compounds and in addition sulphur compounds, in particular H₂S. Sensors are then selected that are sensitive for organic compounds and for H₂S. Once the selection of the sensors is made, The detector 10 is fabricated using processing steps that are known in the art.

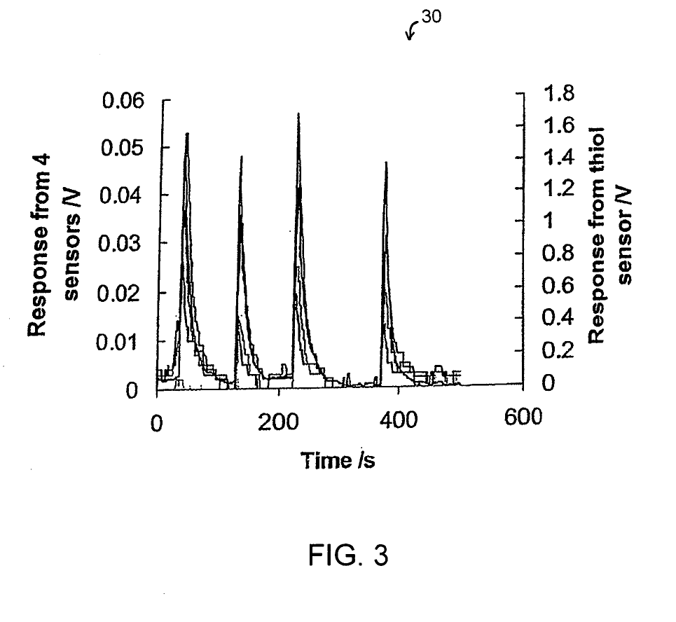

In a variation of the embodiment described above, the detector 10 is arranged for the detection of an odour associated with red meat such as that associated with a red meat processing plant. In this case, the five sensors 12 to 20 are selected to be sensible for propane, methane, alcohol, organic vapour and thiol, respectively. In one specific example, the detector comprises sensors of the type TGS2610, TGS2611, TGS2600, TGS620 and TGS 550 manufactured by FIGARO. FIG. 3 shows plot 30 which is a typical response of the five sensors.

The inventors have observed that organic compounds, in particular aldehydes, and sulfur compounds, in particular reduced sulfur compounds are characteristic for the odour associated with red meat. Therefore the fabricated detector 10 comprises in this embodiment sensors for these components. More specifically the sulfur compounds and organic compounds include hydrogen sulfide, dimethyl sulfide, dimethydisulfide, methyl mercaptan, 3-methyl butanal, 2 methyl propanal and heptanal. Once the selection of the sensors was made, the fabrication of the detector includes processing steps that are known in the art.

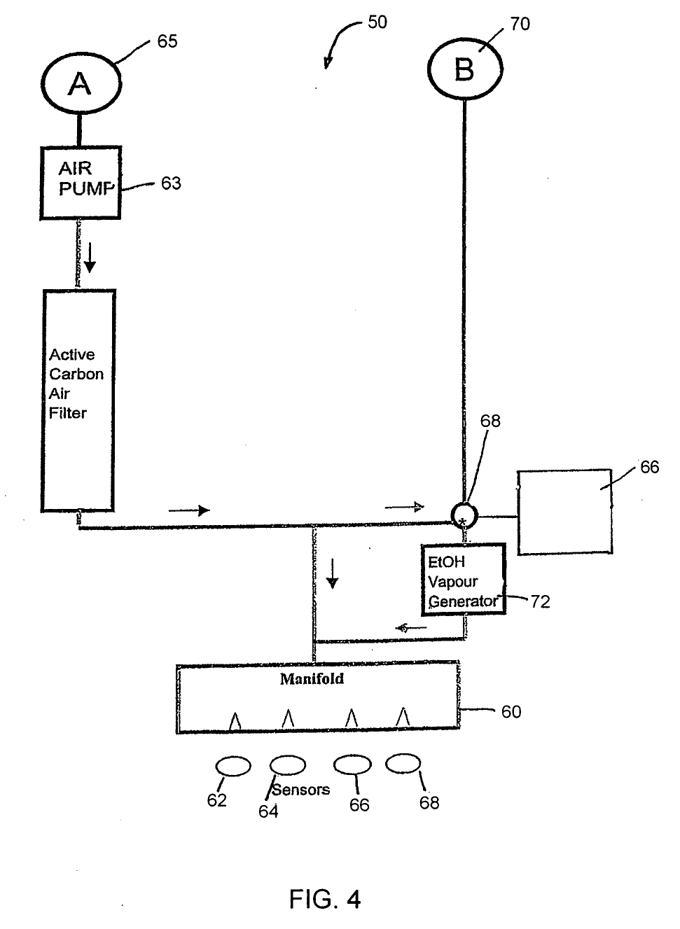

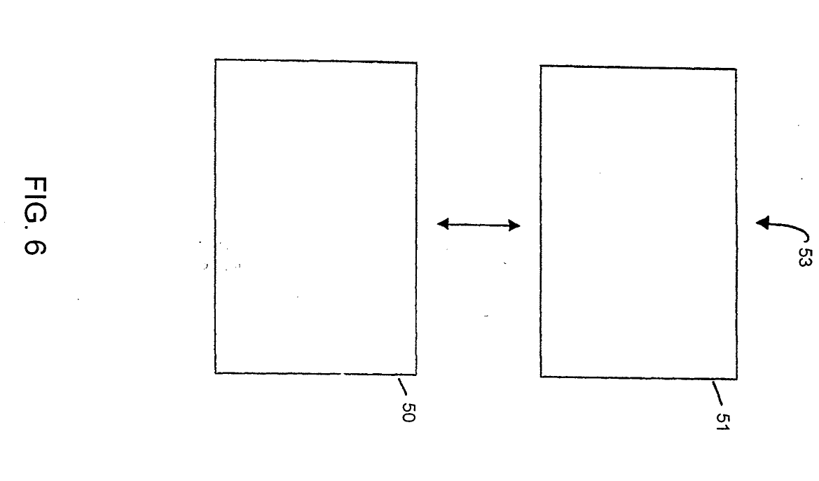

Referring to FIGS. 4 and 6, a detector for detecting molecules conveyed through a gaseous medium according to an embodiment of the invention and a method of detecting molecules conveyed through a gaseous medium are now described. In this embodiment the molecules conveyed through the gaseous medium result in an airborne odour and the detector is a detector for the airborne odour.

FIG. 4 shows the detector 50 which comprises four sensors 62, 64, 66 and 68. In use the sensors 62-68 are exposed to the odour and molecules related to the odour adsorb at the sensor surfaces and are detectable as the electrical properties of the surfaces change when a quantity of the molecules are adsorbed at the surfaces.

The detector 50 comprises electronic components (not shown) that detect the changes of the electrical sensor surface properties and generate electronic data that is associated with a quantity of the detected compounds.

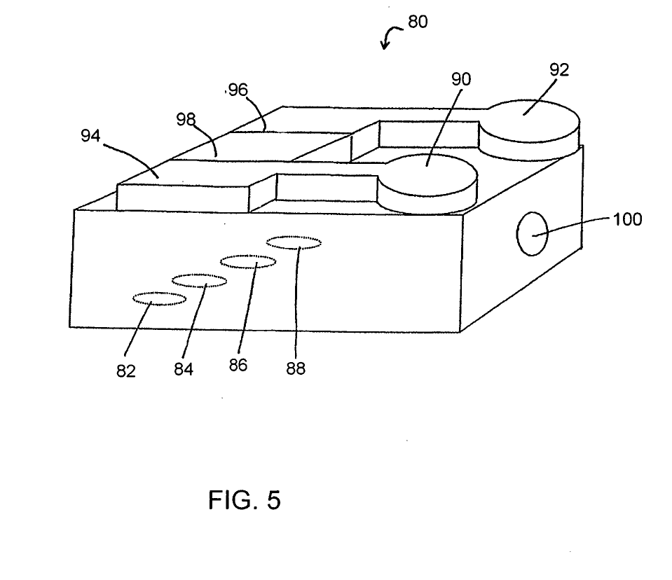

FIG. 6 shows a system 53 comprising the detector 50 and a computer 51, such as a personal computer comprising a processor for executing software routines. The electronic data generated by the detector 50 is directed to an output (not shown) of the detector 50 which is in communication with the computer 51. For example, the detector 50 may be directly connected to the computer 51 using a suitable bus. In a variation of this embodiment that detector 50 is replaced by the detector 80 shown in FIG. 5.

The detector 50 also comprises a manifold 60 that has openings over the surfaces of the sensors 62 to 68 so that a fluid that is direct through the manifold 60 can exit through the openings to interact with the sensor surfaces.

The detector 50 comprises an air pump 63 that is activated by a timer 65. The air pump 63 pumps air through an active carbon filter 66 which is then directed through the manifold 60 to the sensor surfaces to flush the sensor surfaces with filtered air. As in use the detector 50 is exposed to odours, odour molecules will adsorb on the sensor surfaces and flushing the sensor surfaces with the filtered and therefore cleaned air will remove at least a portion of the adsorbed molecules so as to clean the sensor surfaces. Further, the flushing with the cleaned air prevents that molecules associated with the odour adsorb during the flushing process.

The detector 50 also comprises a tank 66 which comprises a liquid, in this case ethanol, to which a calibrated sensor would give a known response. A solenoid valve 68 is controlled by timer 70. During a calibration operation cleaned air is directed through the evaporator 72 and the solenoid valve 68 is opened so that a predetermined amount of evaporated ethanol (having a predetermined concentration) is generated by the evaporator 72 and is directed through manifold 60 to the surfaces of sensors 62-68. The response of the sensors is monitored and if the response is not the known response, the sensors are re-calibrated, for example by adjusting an amplification of an electronic amplifier (not shown) and thereby adjusting the sensitivity.

In this embodiment the detector 50 comprises timers 65 and 70. The timers 65 and 70 are arranged to activate the air pump 62 and the solenoid valve 66 in predetermined time intervals such as once every week. In this embodiment, the detector 50 produces in use electronic data which are transmitted to computer 51 which is, in this embodiment, at a location remote from the detector 50. Therefore, it is possible to monitor the detector response from the remote location such as from another region, state or country. For example, the computer 51 may be arranged to receive the data via another computer (not shown) and via the internet.

In this embodiment, the detector 50 is also arranged so that the sensitivity adjustment can be activated from the remote location, using the computer 51 and a suitable software routine to generate suitable digital data which can be received by a receiver (not shown) of the detector 50 to adjust the sensitivity.

As the timers 65 and 70 allow automated operation and as monitoring of the sensors 62-68 as well as adjusting the sensitivity of the sensors 62-68 are possible from the remote location, it is possible to clean the sensor surfaces and to calibrate the sensors 62-68 automatically or from the remote location. For example, for calibration purposes a processor of the computer 51 may execute a software routine that takes into account the response of the sensors 62-68 and that effects adjustment of the sensitivity in an automated manner.

It is to be appreciated that the detector 50 may not necessarily comprise timers. In a variation of this embodiment, the detector 50 may be arranged so that the air pump 63 and the solenoid valve 68 and are activated from the remote location. In this case a software routine may be arranged to effect flushing of the sensor surfaces and calibration in an automated manner. Alternatively, the detector 50 may comprise an electronic circuitry that controls the valve 66 and the air pump 63 in an automated manner.

In this specific embodiment the timer 65 is set so that the sensor surfaces are flushed with cleaned air once a week for approximately 30 minutes at a rate of approximately 50 mL/min to clean the sensor surfaces. For calibrating the sensors, timer 65 is set to flush the sensor surfaces for approximately 15 minutes. Timer 70 then activates solenoid valve 68 so that cleaned air and ethanol are directed to the evaporator 72 at which a vapour of the ethanol is generated which is directed through the manifold 60 to the sensor surfaces (at a rate of 15-20 mL/min and for approximately 10 min). After the solenoid valve is closed, air pump 63 continues to pump air which then is only directly directed into the manifold 60 to flush the sensor surfaces with cleaned air for approximately 10 min.

FIG. 5 shows a detector according to another embodiment of the present invention. FIG. 5 shows the detector 80 which comprises four sensors 82, 84, 86 and 88. In this embodiment the sensors are tin-oxide sensors that have sensor surfaces that are particularly sensitive for specific compounds. In use the sensors 82-88 are exposed to the odour and molecules related to the odour adsorb at the sensor surfaces and are detectable as the electrical properties of the surfaces change when a quantity of the molecules are adsorbed at the surfaces.

The detector 80 comprises electronic components (not shown) that detect the changes of the electrical sensor surface properties and generate electronic data that is associated with a quantity of the detected compounds.

The detector 80 also comprises blowers 90 and 92. Blower 90 blows air through an activated carbon filter 94 to the sensors 82 to 88. In use blower 92 also blows air through an activated carbon filter 96, but the cleaned air is directed past a slow release vessel 98 which is filled with ethanol so that ethanol vapour is generated.

Similar to the detector 50, the detector 80 comprises timers (not shown) which activate the blowers 90 and 92. The detector 80 is in use exposed to odours and odour molecules will adsorb on the sensor surfaces. Flushing the sensor surfaces with the cleaned air removes at least a portion of the adsorbed molecules so as to clean the sensor surfaces.

During a calibration operation the ethanol vapour is directed to the surfaces of sensors 82 to 88. The response of the sensors is monitored and if the response is not the known response, the sensors are re-calibrated, for example by adjusting an amplification of an electronic amplifier (not shown) and thereby adjusting the sensitivity.

The timers are arranged to activate the blowers 90 and 92 in predetermined time intervals. In this specific embodiment the timers are set so that the sensor surfaces are flushed with cleaned air once a day for approximately 30 minutes at a rate of approximately 50 mL/min to clean the sensor surfaces. For calibrating the sensors, the timers are set to flush the sensor surfaces for approximately 15 minutes. The timers then activate the blowers 90 and 92 so that cleaned air and ethanol are directed to the evaporator 98 at which a vapour of the ethanol is generated which is directed to the sensor surfaces at a rate of 15-20 mL/min and for approximately 10 min). Blower 90 continues to pump air directly directed to the sensor surfaces for approximately 10 min.

In one embodiment of the present invention the detector 80 is arranged to initially flush the sensor surfaces 82 to 88 with cleaned air and ethanol vapour to clean and calibrate the sensor surfaces. Molecules associated with an odour or for diagnostic purposes are then blown to the sensor surfaces 82 to 88 by blower 100 and a rate at which an electrical signal associated with the coupling of the molecules to the sensor surfaces 82 to 88 rises is measured. Then a maximum of the electrical signal is measured before the detector surfaces are flushed again. During the flushing the rate at which the electrical signal decays is measured. Detection of the rise of the electrical signal and/or of the decay of the electrical signal provides further information for the diagnosis and characterisation of the molecules conveyed through the gaseous medium.

Although the invention has been described with reference to particular examples, it will be appreciated by those skilled in the art that the invention may be embodied in many other forms. For example, the detector 50 may not be arranged for flushing with air but may be arranged for flushing with another suitable fluid. Also, ethanol is only one example of a fluid which can be used for calibration purposes and other examples may include other alcohols and other fluids.

Further, it is to be appreciated that the detectors 10, 50 and 80 may be used to detect molecules conveyed through a gaseous medium other than those that result in an odour. For example, the molecules may relate to an odourless fluid such as an odourless toxic gas (for example carbon monoxide). In addition, the sensors may not necessarily have tin-oxide sensor surfaces but may have other types of sensor surfaces. The detectors may also comprise surface acoustic wave sensors, conducting polymer sensors, quartz crystal microbalance sensors, fibre optic sensors, or other metal oxide sensors. Further, the detectors may comprise more or less than five sensors. It is also to be appreciated that the detector may only comprise one sensor that is sensitive for a sulphur compound and for an organic compound. In other variations the detectors may be arranged for the detection of an odour associated with white meat, with solvents, may be an odour emitted from a metal, food or chemical processing plant or may in general relate to any matter or molecules with which humans may be in contact or to which humans may be exposed.

1. A method for detecting molecules conveyed through a gaseous medium, the method comprising the steps of:
exposing a detector to molecules emitted from at least one of a sewage plant, a rubbish processing plant and a meat processing plant, the detector being sensitive for organic molecules and for molecules that contain sulphur and
measuring a change in an electrical property of the sensor and thereby detecting the molecules.

2. The method as claimed in claim 1 wherein the step of exposing the detector comprises:
exposing a first sensing surface to the molecules, the first sensing surface being sensitive for an organic compound and
exposing a second sensing surface to the molecules, the second sensing surface being sensitive for a sulphur compound.

3. The method as claimed in claim 1 wherein the step of measuring a change of an electrical property comprises measuring a change of an electrical property of the first and second sensing surfaces and thereby detecting the molecules.

4. The method as claimed in claim 1 wherein the molecules conveyed through a gaseous medium relate to an odour.

5. The method as claimed in claim 1 wherein the source is a sewage plant and wherein the first sensing surface is sensitive for at least one of CO; volatile fatty acids; ammonia; hydrocarbons such as methane, isobutane, propane, toluene, xylene; aromatics; alcohols and other oxygenated compounds.

6. The method as claimed in claim 5 wherein the step of exposing the detector comprises:
exposing a first sensing surface to the molecules, the first sensing surface being sensitive for an organic compound and
exposing a second sensing surface to the molecules, the second sensing surface being sensitive for H₂S.

7. The method as claimed in claim 4 wherein the detector is exposed to molecules emitted from a red meat processing plant.

8. The method as claimed in claim 7 wherein the step of exposing the detector comprises:
exposing a first sensing surface to the molecules, the first sensing surface being sensitive for aldehydes and
exposing a second sensing surface to the molecules, the second sensing surface being sensitive for a sulphur compound.

9. The method as claimed in claim 8 wherein the second surface is sensitive for a reduced sulfur compound.

10. The method as claimed in claim 8 wherein the step of exposing a first sensing surface to the odour comprises exposing a first sensing surface that is sensitive for at least one of propane, methane, an alcohol, and an organic vapour to the odour.

11. A detector for detecting molecules conveyed through a gaseous medium, the detector comprising:
at least one sensor element, the or each sensor element having a sensor surface for sensing the molecules and
a device for directing a fluid that is substantially free of the molecules to be detected to the or each sensor surface, the device having a control mechanism for controlling an amount of the fluid that is directed to the or each sensor surface wherein the device for directing the fluid is arranged for cleaning the or each sensor.

12. The detector as claimed in claim 11 wherein the device for directing the fluid comprises a manifold that is arranged so that the fluid is guided to the or each sensor surface.

13. The detector as claimed in claim 11 wherein the control mechanism is remotely controlled so that the control mechanism can be activated from a remote location and the detector is arranged for remotely controlled cleaning of the or each sensor.

14. The detector as claimed in claim 11 having a timer that is arranged to activate the control mechanism in predetermined time intervals so that the or each sensor can be cleaned in the predetermined time intervals.

15. The detector as claimed in claim 11 wherein the control mechanism is remotely controlled so that the control mechanism can be activated from a remote location and the detector is arranged for remotely controlled calibrating of the or each sensor.

16. The detector as claimed in claim 11 having a timer that is arranged to activate the control mechanism in predetermined time intervals so that the or each sensor can be calibrated in the predetermined time intervals.

17. The detector as claimed in claim 11 being arranged to flush the or each sensor surface with substantially clean air to remove adsorbed molecules, from the or each sensor surface.

18. The detector as claimed in claim 11 comprising a filter to filter and thereby clean air so that substantially clean air is directed to the or each sensor surface.

19. The detector as claimed in claim 17 being arranged to direct a known quantity or concentration of the fluid to the or each sensor surface for which a calibrated sensor surface would give known response.

20. The detector as claimed in claim 11 wherein the fluid comprises an alcohol.

21. The detector as claimed in claim 11 wherein the device comprises a vapour generator that is arranged to generate a vapour having predetermined concentration.

22. The detector as claimed in claim 11 comprising an arrangement for mounting sensors which allows the sensors to be exchanged so that the sensors can be selected to suit a particular requirement.

23. A method of detecting molecules conveyed through the air using the detector as claimed in claims 11.

24. The method as claimed in claim 23 comprising the steps of flushing the or each sensor surface with the fluid that is substantially free of the molecules to clean the or each sensor surface from contaminating molecules and thereafter exposing the or each surface to the molecules conveyed through the gaseous medium.

25. The method as claimed in claim 24 comprising the step of detecting a rate at which an electrical signal associated with the coupling of the molecules changes.

26. The method as claimed in claim 24 comprising the step of detecting a maximum of an electrical signal associated with the coupling of the molecules conveyed through the gaseous medium to the or each sensor surface.

27. The method as claimed in claim 24 comprising the step of flushing the or each sensor surface with the fluid that is substantially free of the molecules to clean the or each sensor surface after exposure to the molecules conveyed through the gaseous medium.

28. The method as claimed in claim 27 comprising the step of detecting a rate at which an electrical signal associated with de-coupling of the molecules decays.
